(19) United States
(12) Patent Application Publication
(10) Pub. No.: US 2025/0271744 A1
(43) Pub. Date: Aug. 28, 2025

(54) LIGHT SOURCE APPARATUS AND PROJECTOR

(71) Applicant: SEIKO EPSON CORPORATION, Tokyo (JP)

(72) Inventor: Toshihiro MARUYAMA, AZUMINO-SHI (JP)

(21) Appl. No.: 19/063,854

(22) Filed: Feb. 26, 2025

(30) Foreign Application Priority Data
Feb. 28, 2024 (JP) 2024-028394

(51) Int. Cl. G03B 21/20

(52) U.S. Cl. CPC G03B 21/2053

(57) ABSTRACT

A light source apparatus includes a first light source configured to output first light; a first sensor configured to detect a first measured value corresponding to a temperature of the first light source; and a controller configured to control an output from the first light source based on the first measured value.

The present application is based on, and claims priority from JP Application Serial Number 2024-028394, filed Feb. 28, 2024, the disclosure of which is hereby incorporated by reference herein in its entirety.

### BACKGROUND

### 1. Technical Field

The present disclosure relates to a light source apparatus and a projector.

### 2. Related Art

JP-A-2015-154163 discloses a projector including an external light quantity sensor that measures external illuminance and an internal light quantity sensor that measures the light quantity of the light from a light source via a light modulator, and that adjusts at least one of the light quantity of the light from the light source and the luminance of an image based on measured values provided from the two sensors.

JP-A-2015-154163 is an example of the related art.

In the related art described above, since it is necessary to provide two light quantity sensors in the projector, the number and the cost of the parts of the

### SUMMARY

A light source apparatus according to an aspect of the present disclosure includes: a first light source configured to output first light; a first sensor configured to detect a first measured value corresponding to a temperature of the first light source; and a controller configured to control an output from the first light source based on the first measured value.

A projector according to another aspect of the present disclosure includes: the light source apparatus according to the aspect described above; a light modulator configured to modulate light output from the light source apparatus; and a projection system configured to project the light modulated by the light modulator.

### BRIEF DESCRIPTION OF THE DRAWINGS

FIG. 1 is a block diagram diagrammatically showing the configuration of a light source apparatus according to a first embodiment.

FIG. 2 shows an example of a result of measurement of the output from a light source.

FIG. 3 is a flowchart showing a light source control process in the first embodiment.

FIG. 4 is a block diagram diagrammatically showing the configuration of a light source apparatus according to a second embodiment.

FIG. 5 is a flowchart showing a light source control process in the second embodiment.

FIG. 6 is a block diagram diagrammatically showing the configuration of a light source apparatus according to a third embodiment.

FIG. 7 is a flowchart showing a light source control process in the third embodiment.

FIG. 8 diagrammatically shows the configuration of a projector including a light source apparatus.

### DESCRIPTION OF EMBODIMENTS

Embodiments of the present disclosure will be described below with reference to the drawings.

In the following drawings, elements may be drawn at different dimensional scales for clarity of the elements.

### First Embodiment of Light Source Apparatus

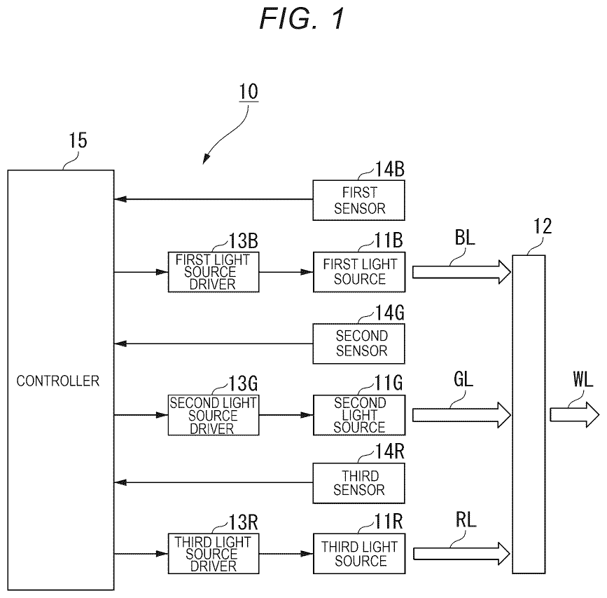

FIG. 1 is a block diagram diagrammatically showing the configuration of a light source apparatus 10 according to a first embodiment. The light source apparatus 10 includes a first light source 11B, a second light source 11G, a third light source 11R, a light combiner 12, a first light source driver 13B, a second light source driver 13G, a third light source driver 13R, a first sensor 14B, a second sensor 14G, a third sensor 14R, and a controller 15, as shown in FIG. 1.

The first light source 11B outputs first light BL. The first light source 11B outputs blue light as the first light BL by way of example. For example, the first light source 11B may include one or more blue laser diodes to output blue light as the first light BL. The first light source driver 13B supplies the first light source 11B with a first drive current. The output from the first light source 11B is controlled by the first drive current.

The second light source 11G outputs second light GL. The second light source 11G outputs green light as the second light GL by way of example. For example, the second light source 11G may include one or more green laser diodes to output green light as the second light GL. The second light source driver 13G supplies the second light source 11G with a second drive current. The output from the second light source 11G is controlled by the second drive current.

The third light source 11R outputs third light RL. The third light source 11R outputs red light as the third light RL by way of example. For example, the third light source 11R may include one or more red laser diodes to output red light as the third light RL. The third light source driver 13R supplies the third light source 11R with a third drive current. The output from the third light source 11R is controlled by the third drive current.

The light combiner 12 combines the first light BL, the second light GL, and the third light RL with one another. The light combiner 12 outputs white light WL as a result of the combination of the first light BL, the second light GL, and the third light RL. That is, the light source apparatus 10 outputs the white light WL.

The first light source driver 13B supplies the first light source 11B with the first drive current based on a first control signal output from the controller 15. The value of the first drive current supplied from the first light source driver 13B to the first light source 11B is controlled by the controller 15.

The second light source driver 13G supplies the second light source 11G with the second drive current based on a second control signal output from the controller 15. The value of the second drive current supplied from the second light source driver 13G to the second light source 11G is controlled by the controller 15.

The third light source driver 13R supplies the third light source 11R with the third drive current based on a third control signal output from the controller 15. The value of the third drive current supplied from the third light source driver 13R to the third light source 11R is controlled by the controller 15.

The first sensor 14B detects a first measured value corresponding to the temperature of the first light source 11B. In the present embodiment, the first measured value is the temperature. The first measured value is not limited to the temperature, and may, for example, be the value of a voltage applied to the first light source 11B. The first sensor 14B outputs an electric signal indicating the first measured value to the controller 15.

The second sensor 14G detects a second measured value corresponding to the temperature of the second light source 11G. In the present embodiment, the second measured value is the temperature. The second measured value is not limited to the temperature, and may, for example, be the value of a voltage applied to the second light source 11G. The second sensor 14G outputs an electric signal indicating the second measured value to the controller 15.

The third sensor 14R detects a third measured value corresponding to the temperature of the third light source 11R. In the present embodiment, the third measured value is the temperature. The third measured value is not limited to the temperature, and may be the value of a voltage applied to the third light source 11R. The third sensor 14R outputs an electric signal indicating the third measured value to the controller 15. For example, the first sensor 14B, the second sensor 14G, and the third sensor 14R are each a thermistor. In general, a thermistor processes the output from the sensor in the form of voltage, and can therefore directly process the measured value when the measured value is a voltage.

The controller 15 separately controls the output from the first light source 11B, the output from the second light source 11G, and the output from the third light source 11R. As will be described later in detail, the controller 15 controls the output from the first light source 11B based on the first measured value detected by the first sensor 14B. The controller 15 further controls the output from the second light source 11G based on the second measured value detected by the second sensor 14G. Moreover, the controller 15 controls the output from the third light source 11R based on the third measured value detected by the third sensor 14R.

More specifically, the controller 15 controls the output from the first light source 11B by controlling the first drive current, which is supplied to the first light source 11B, based on the first measured value. The controller 15 further controls the output from the second light source 11G by controlling the second drive current, which is supplied to the second light source 11G, based on the second measured value. Moreover, the controller 15 controls the output from the third light source 11R by controlling the third drive current, which is supplied to the third light source 11R, based on the third measured value.

For example, the controller 15 includes one or more processors and one or more memories. For example, the processor is configured with a CPU (central processing unit). Some or all functions of the processor may be implemented by a circuit such as a digital signal processor (DSP), an application specific integrated circuit (ASIC), a programmable logic device (PLD), or a field programmable gate array (FPGA). The processor carries out various processes in parallel or sequentially.

The memory includes a nonvolatile memory that stores programs necessary for causing the processor to carry out the various processes, various setting data, and the like, and a volatile memory used as a temporary data saving destination when the processor carries out the various processes. For example, the nonvolatile memory is an electrically erasable programmable read-only memory (EEPROM) or a flash memory. The volatile memory is, for example, a random access memory (RAM).

Control parameters necessary for controlling the first light source 11B, the second light source 11G, and the third light source 11R are stored in advance in the nonvolatile memory of the controller 15. A method for acquiring the control parameters necessary for controlling the first light source 11B, the second light source 11G, and the third light source 11R will be described below. The method for acquiring the control parameters includes first to fifth steps described below.

### First Step: Set Measurement Conditions

In the first step, multiple different measurement conditions are set in accordance with the combination of the first measured value corresponding to the temperature of the first light source 11B and the first drive current supplied to the first light source 11B. In the following description, the first measured value set as a measurement condition may be referred to as a temperature condition value, and the value of the first drive current set as another measurement condition may be referred to as a current condition value.

### Second Step: Measure Output from Light Source

In the second step, when the first light source 11B is driven under each of the measurement conditions, the power of the first light BL output from the first light source 11B and the values of the XYZ components in the CIE XYZ color system are measured. The CIE XYZ color system is an example of a first color system. In the following description, the value of measured power may be referred to as a power measured value, the value of a measured X component may be referred to as an X-component measured value, the value of a measured Y component may be referred to as a Y-component measured value, and the value of a measured Z component may be referred to as a Z-component measured value.

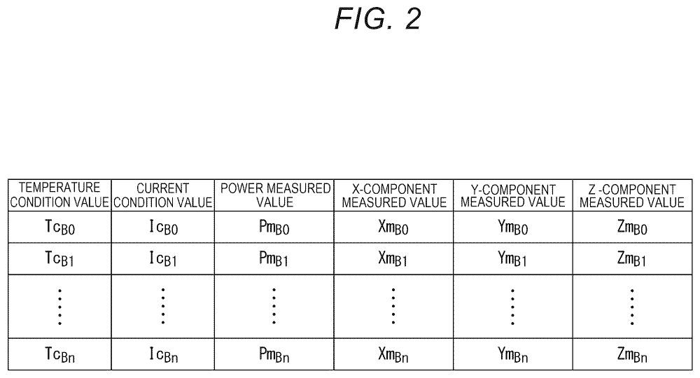

FIG. 2 shows an example of a result of the measurement of the output from a light source. For example, when the first light source 11B is driven under a measurement condition that is the combination of a temperature condition value Tc_{B0} and a current condition value Ic_{B0}, a power measured value Pm_{B0}, an X-component measured value Xm_{B0}, a Y-component measured value Ym_{B0}, and a Z-component measured value Zm_{B0} are obtained, as shown in FIG. 2.

Furthermore, for example, when the first light source 11B is driven under a measurement condition that is the combination of a temperature condition value Tc_{B1} and a current condition value Ic_{B1}, a power measured value Pm_{B1}, an X-component measured value Xm_{B1}, a Y-component measured value Ym_{B1}, and an Z-component measured value Zm_{B1} are obtained, as shown in FIG. 2.

Moreover, for example, when the first light source 11B is driven under a measurement condition that is the combination of a temperature condition value TC_{Bn} and a current condition value Ic_{Bn}, a power measured value Pm_{Bn}, an X-component measured value Xm_{Bn}, a Y-component measured value Ym_{Bn}, and a Z-component measured value Zm_{Bn} are obtained, as shown in FIG. 2.

### Third Step: Calculate Output Fixing Coefficients

In the third step, output fixing coefficients are calculated based on the temperature condition value, the current condition value, and the power measured value. For example, the current condition value Ic_{B0} can be expressed by a polynomial having variables that are the temperature condition value TC_{B0} and the power measured value Pm_{B0}, as indicated by Expression (1) below. Similarly, the current condition value Ic_{Bn} can be expressed by a polynomial having variables that are the temperature condition value Tc_{Bn} and the power measured value Pm_{Bn}, as indicated by Expression (2) below. Note that other current condition values such as the current condition value Ic_{B1} can each be similarly expressed by a polynomial although not shown. That is, polynomials the number of which is equal to the number of measurement conditions are obtained. In Expressions (1) and (2), coefficients k_{B00} to k_{Bij} are the output fixing coefficients.

$$\{ \begin{matrix}{Ic}_{B 0} = {k}_{{B}_{00}} \cdot {Tc}_{B 0}^{0} \cdot {Pm}_{B 0}^{0} + … + {k}_{{B}_{i j}} \cdot {Tc}_{B 0}^{i} \cdot {Pm}_{B 0}^{j} & ( 1 ) \\ {Ic}_{B n} = {k}_{{B}_{00}} \cdot {Tc}_{Bn}^{0} \cdot {Pm}_{Bn}^{0} + … + {k}_{{B}_{ij}} \cdot {Tc}_{Bn}^{i} \cdot {Pm}_{Bn}^{j} & ( 2 )\end{matrix}$$

When the polynomials described above are transformed into a determinant, Expression (3) below is obtained. The output fixing coefficients k_{B00} to k_{Bij} are calculated by solving simultaneous equations based on Expression (3) below.

$$( \begin{matrix}{Ic}_{B 0} \\ ⋮ \\ {Ic}_{B n}\end{matrix} ) = ( \begin{matrix}{Tc}_{B 0}^{0} \cdot {Pm}_{B 0}^{0} & … & {Tc}_{B 0}^{i} \cdot {Pm}_{B 0}^{j} \\ ⋮ & ⋱ & ⋮ \\ {Tc}_{xn}^{0} \cdot {Pm}_{B 0}^{0} & … & {Tc}_{Bn}^{0} \cdot {Pm}_{B n}^{j}\end{matrix} ) ( \begin{matrix}{k}_{{B}_{00}} \\ ⋮ \\ {k}_{{B}_{ij}}\end{matrix} ) \qquad ( 3 )$$

Note that the relationship among n, i, and j in Expressions (1), (2), and (3) is expressed by Expression (4) below.

$$n = ( i + 1 ) ( j + 1 ) \qquad ( 4 )$$

### Fourth Step: Acquire Standard Values of XYZ Components

In the fourth step, standard values of the XYZ components are acquired. For example, any one of the X-component measured values is acquired as a standard value X_{B0} of the X component. Furthermore, any one of the Y-component measured values is acquired as a standard value Y_{B0} of the Y component. Moreover, any one of the Z-component measured values is acquired as a standard value Z_{B0} of the Z component.

### Fifth Step: Calculate Wavelength Shift Correction Coefficients

In the fifth step, wavelength shift correction coefficients are calculated. First, spectra of the first light BL output from the first light source 11B are measured, and the measured spectra are so normalized that the sum of the spectra becomes one. The value of the X component is then calculated from the normalized spectra. The proportion of the X component is then calculated by dividing the calculated value of the X component by the standard value X_{B0} of the X component. The proportion of the X component is then divided by the temperature condition value used in the spectrum measurement to calculate a wavelength shift correction coefficient K_{BX} of the X component.

The value of the Y component is then calculated from the normalized spectra. The proportion of the Y component is then calculated by dividing the calculated value of the Y component by the standard value Y_{B0} of the Y component. The proportion of the Y component is then divided by the temperature condition value used in the spectrum measurement to calculate a wavelength shift correction coefficient K_{BY} of the Y component.

The value of the Z component is then calculated from the normalized spectra. The proportion of the Z component is then calculated by dividing the calculated value of the Z component by the standard value Z_{B0} of the Z component. The proportion of the Z component is then divided by the temperature condition value used in the spectrum measurement to calculate a wavelength shift correction coefficient K_{BZ} of the Z component.

As described the above, output fixing coefficients k_{B00} to k_{Bij}, the standard value X_{B0} of the X component, the standard value Y_{B0} of the Y component, the standard value Z_{B0} of the Z component, the wavelength shift correction coefficient K_{BX} of the X component, the wavelength shift correction coefficient K_{BY} of the Y component, and the wavelength shift correction coefficient K_{BZ} of the Z component are obtained as the control parameters necessary for controlling the first light source 11B by executing the first to fifth steps described above for the first light source 11B.

The output fixing coefficients k_{B00} to k_{Bij} are an example of a first coefficient set in advance in correspondence with the first light source 11B. The standard value X_{B0} of the X component, the standard value Y_{B0} of the Y component, and the standard value Z_{B0} of the Z component are examples of a first standard value expressed in the first color system and set in advance in correspondence with the first light source 11B. The wavelength shift correction coefficient K_{BX} of the X component, the wavelength shift correction coefficient K_{BY} of the Y component, and the wavelength shift correction coefficient K_{BZ} of the Z component are examples of a first correction coefficient set in advance in correspondence with the first light source 11B.

Similarly, output fixing coefficients k_{G00} to k_{Gij}, a standard value X_{G0} of the X component, a standard value Y_{G0} of the Y component, a standard value Z_{G0} of the Z component, a wavelength shift correction coefficient K_{GX} of the X component, a wavelength shift correction coefficient K_{GY} of the Y component, and a wavelength shift correction coefficient K_{GZ} of the Z component are obtained as the control parameters necessary for controlling the second light source 11G by executing the first to fifth steps described above for the second light source 11G.

The output fixing coefficients k_{G00} to K_{Gij} are an example of a second coefficient set in advance in correspondence with the second light source 11G. The standard value X_{G0} of the X component, the standard value Y_{G0} of the Y component, and the standard value Z_{G0} of the Z component are examples of a second standard value expressed in the first color system and set in advance in correspondence with the second light source 11G. The wavelength shift correction coefficient K_{GX} of the X component, the wavelength shift correction coefficient K_{GY} of the Y component, and the wavelength shift correction coefficient K_{GZ} of the Z component are examples of a second correction coefficient set in advance in correspondence with the second light source 11G.

Similarly, output fixing coefficients k_{R00} to K_{Rij}, a standard value X_{R0} of the X component, a standard value Y_{R0} of the Y component, a standard value Z_{R0} of the Z component, a wavelength shift correction coefficient K_{RX} of the X component, a wavelength shift correction coefficient K_{RY} of the Y component, and a wavelength shift correction coefficient K_{RZ} of the Z component are obtained as the control parameters necessary for controlling the third light source 11R by executing the first to fifth steps described above for the third light source 11R.

The output fixing coefficients k_{R00} to k_{Rij} are an example of a third coefficient set in advance in correspondence with the third light source 11R. The standard value X_{R0} of the X component, the standard value Y_{R0} of the Y component, and the standard value Z_{R0} of the Z component are examples of a third standard value expressed in the first color system and set in advance in correspondence with the third light source 11R. The wavelength shift correction coefficient K_{RX} of the X component, the wavelength shift correction coefficient K_{RY} of the Y component, and the wavelength shift correction coefficient K_{RZ} of the Z component are examples of a third correction coefficient set in advance in correspondence with the third light source 11R.

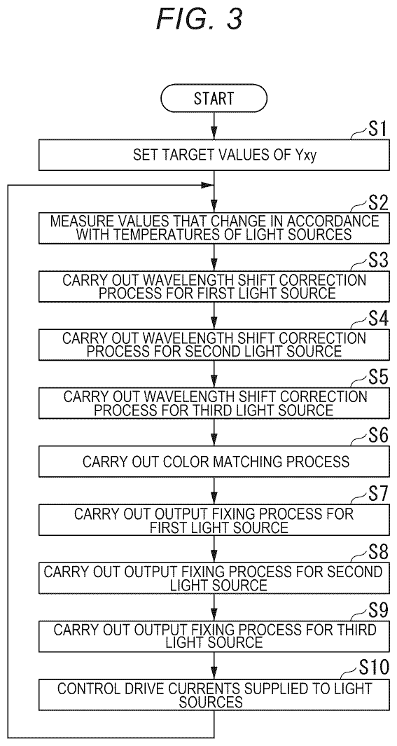

The method for acquiring the control parameters stored in advance in the nonvolatile memory of the controller 15 has been described above. A light source control process carried out by the controller 15 will be described below with reference to FIG. 3. FIG. 3 is a flowchart showing the light source control process carried out by the controller 15.

The controller 15 first sets a target value of the Y component and target values of the color coordinate xy (step S1), as shown in FIG. 3. The target value of the Y component and the target values of the color coordinate xy are examples of a target value expressed in the first color system.

The controller 15 subsequently measures values that change in accordance with the temperatures of the first light source 11B, the second light source 11G, and the third light source 11R (step S2). Specifically, the controller 15 acquires a first measured value Tm_{B} corresponding to the temperature of the first light source 11B based on an output signal from the first sensor 14B. The controller 15 further acquires a second measured value Tm_{G} corresponding to the temperature of the second light source 11G based on the output signal from the second sensor 14G. The controller 15 still further acquires a third measured value Tm_{R} corresponding to the temperature of the third light source 11R based on the output signal from the third sensor 14R.

The controller 15 subsequently carries out a wavelength shift correction process for the first light source 11B (step S3). Specifically, the controller 15 reads the standard value X_{B0} of the X component and the wavelength shift correction coefficient K_{BX} of the X component out of the control parameters relating to the first light source 11B from the memory. The controller 15 then corrects the standard value X_{B0} of the X component based on the first measured value Tm_{B} and the wavelength shift correction coefficient K_{BX} of the X component. Specifically, the controller 15 calculates a reference value X_{B1} of the X component relating to the first light source 11B by substituting the standard value X_{B0} of the X component, the wavelength shift correction coefficient K_{BX} of the X component, and the first measured value Tm_{B} into Expression (5) below.

The controller 15 further reads the standard value Y_{B0} of the Y component and the wavelength shift correction coefficient K_{BY} of the Y component out of the control parameters relating to the first light source 11B from the memory. The controller 15 then corrects the standard value Y_{B0} of the Y component based on the first measured value Tm_{B} and the wavelength shift correction coefficient K_{BY} of the Y component. Specifically, the controller 15 calculates a reference value Y_{B1} of the Y component relating to the first light source 11B by substituting the standard value Y_{B0} of the Y component, the wavelength shift correction coefficient K_{BY} of the Y component, and the first measured value Tm_{B} into Expression (6) below.

The controller 15 still further reads the standard value Z_{B0} of the Z component and the wavelength shift correction coefficient K_{BZ} of the Z component out of the control parameters relating to the first light source 11B from the memory. The controller 15 then corrects the standard value Z_{B0} of the Z component based on the first measured value Tm_{B} and the wavelength shift correction coefficient K_{BZ} of the Z component. Specifically, the controller 15 calculates a reference value Z_{B1} of the Z component relating to the first light source 11B by substituting the standard value Z_{B0} of the Z component, the wavelength shift correction coefficient K_{BZ} of the Z component, and the first measured value Tm_{B} into Expression (7) below.

$$\{ \begin{matrix}{X}_{B 1} = {X}_{B 0} \cdot {K}_{B X} \cdot {Tm}_{B} & ( 5 ) \\ {Y}_{B 1} = {Y}_{B 0} \cdot {K}_{B Y} \cdot {Tm}_{B} & ( 6 ) \\ {Z}_{B 1} = {Z}_{B 0} \cdot {K}_{B Z} \cdot {Tm}_{B} & ( 7 )\end{matrix}$$

The controller 15 subsequently carries out the wavelength shift correction process for the second light source 11G (step S4). Specifically, the controller 15 reads the standard value X_{G0} of the X component and the wavelength shift correction coefficient K_{GX} of the X component out of the control parameters relating to the second light source 11G from the memory. The controller 15 then corrects the standard value X_{G0} of the X component based on the second measured value Tm_{G} and the wavelength shift correction coefficient K_{GX} of the X component. Specifically, the controller 15 calculates a reference value X_{G1} of the X component relating to the second light source 11G by substituting the standard value X_{G0} of the X component, the wavelength shift correction coefficient K_{GX} of the X component, and the second measured value Tm_{G} into Expression (8) below.

The controller 15 further reads the standard value Y_{G0} of the Y component and the wavelength shift correction coefficient K_{GY} of the Y component out of the control parameters relating to the second light source 11G from the memory. The controller 15 then corrects the standard value Y_{G0} of the Y component based on the second measured value Tm_{G} and the wavelength shift correction coefficient K_{GY} of the Y component. Specifically, the controller 15 calculates a reference value Y_{G1} of the Y component relating to the second light source 11G by substituting the standard value Y_{G0} of the Y component, the wavelength shift correction coefficient K_{GY} of the Y component, and the second measured value Tm_{G} into Expression (9) below.

The controller 15 still further reads the standard value Z_{G0} of the Z component and the wavelength shift correction coefficient K_{GZ} of the Z component out of the control parameters relating to the second light source 11G from the memory. The controller 15 then corrects the standard value Z_{G0} of the Z component based on the second measured value Tm_{G} and the wavelength shift correction coefficient K_{GZ} of the Z component. Specifically, the controller 15 calculates a reference value Z_{G1} of the Z component relating to the second light source 11G by substituting the standard value Z_{G0} of the Z component, the wavelength shift correction coefficient K_{GZ} of the component, and the second measured value Tm_{G} into Expression (10) below.

$$\{ \begin{matrix}{X}_{G 1} = {X}_{G 0} \cdot {K}_{GX} \cdot {Tm}_{G} & ( 8 ) \\ {Y}_{G 1} = {Y}_{G 0} \cdot {K}_{GY} \cdot {Tm}_{G} & ( 9 ) \\ {Z}_{G 1} = {Z}_{G 0} \cdot {K}_{GZ} \cdot {Tm}_{G} & ( 10 )\end{matrix}$$

The controller 15 subsequently carries out the wavelength shift correction process for the third light source 11R (step S5). Specifically, the controller 15 reads the standard value X_{R0} of the X component and the wavelength shift correction coefficient K_{RX} of the X component out of the control parameters relating to the third light source 11R from the memory. The controller 15 then corrects the standard value X_{R0} of the X component based on the third measured value Tm_{R} and the wavelength shift correction coefficient K_{RX} of the X component. Specifically, the controller 15 calculates a reference value X_{R1} of the X component relating to the third light source 11R by substituting the standard value X_{R0} of the X component, the wavelength shift correction coefficient K_{RX} of the X component, and the third measured value Tm_{R} into Expression (11) below.

The controller 15 further reads the standard value Y_{R0} of the Y component and the wavelength shift correction coefficient K_{RY} of the Y component out of the control parameters relating to the third light source 11R from the memory. The controller 15 then corrects the standard value Y_{R0} of the Y component based on the third measured value Tm_{R} and the wavelength shift correction coefficient K_{RY} of the Y component. Specifically, the controller 15 calculates a reference value Y_{R1} of the Y component relating to the third light source 11R by substituting the standard value Y_{R0} of the Y component, the wavelength shift correction coefficient K_{RY} of the component, and the third measured value Tm_{R} into Expression (12) below.

The controller 15 still further reads the standard value Z_{R0} of the Z component and the wavelength shift correction coefficient K_{RZ} of the Z component out of the control parameters relating to the third light source 11R from the memory. The controller 15 then corrects the standard value Z_{R0} of the Z component based on the third measured value Tm_{R} and the wavelength shift correction coefficient K_{RZ} of the Z component. Specifically, the controller 15 calculates a reference value Z_{R1} of the Z component relating to the third light source 11R by substituting the standard value Z_{R0} of the Z component, the wavelength shift correction coefficient K_{RZ} of the Z component, and the third measured value Tm_{R} into Expression (13) below.

$$\{ \begin{matrix}{X}_{R 1} = {X}_{R 0} \cdot {K}_{R X} \cdot {Tm}_{R} & ( 11 ) \\ {Y}_{R 1} = {Y}_{R 0} \cdot {K}_{R Y} \cdot {Tm}_{R} & ( 12 ) \\ {Z}_{R 1} = {Z}_{R 0} \cdot {K}_{R Z} \cdot {Tm}_{R} & ( 13 )\end{matrix}$$

The controller 15 subsequently carries out a color matching process (step S6). Specifically, the controller 15 calculates a first power setting value Po_{B} for the first light source 11B, a second power setting value Po_{G} for the second light source 11G, and a third power setting value Po_{R} for the third light source 11R. A target value of the X component is expressed by Expression (14) below. A target value of the Y component is expressed by Expression (15) below. A target value of the Z component is expressed by Expression (16) below.

$$\{ \begin{matrix}X = \frac{Y}{y} x = {Po}_{R} \cdot {X}_{R 1} + P {o}_{G} \cdot {X}_{G 1} + P {o}_{B} \cdot {X}_{B 1} & ( 14 ) \\ Y = Y = P {o}_{R} \cdot {Y}_{R 1} + P {o}_{G} \cdot {Y}_{G 1} + P {o}_{B} \cdot {Y}_{B 1} & ( 15 ) \\ Z = \frac{Y}{y} ( 1 - x - y ) = P {o}_{R} \cdot {Z}_{R 1} + P {o}_{G} \cdot {Z}_{G 1} + P {o}_{B} \cdot {Z}_{B 1} & ( 16 )\end{matrix}$$

When Expressions (14), (15), and (16) described above are transformed into a determinant, Expression (17) below is obtained. The controller 15 solves simultaneous equations based on Expression (17) below to calculate the first power setting value Po_{B} for the first light source 11B, the second power setting value Po_{G} for the second light source 11G, and the third power setting value Po_{R} for the third light source 11R.

$$( \begin{matrix}X \\ Y \\ Z\end{matrix} ) = ( \begin{matrix}\frac{Y}{y} x \\ Y \\ \frac{Y}{y} ( 1 - x - y )\end{matrix} ) = ( \begin{matrix}{X}_{R 1} & {X}_{G 1} & {X}_{B 1} \\ {Y}_{R 1} & {Y}_{G 1} & {Y}_{B 1} \\ {Z}_{R 1} & {Z}_{G 1} & {Z}_{B 1}\end{matrix} ) ( \begin{matrix}{Po}_{R} \\ {Po}_{G} \\ {Po}_{B}\end{matrix} ) \qquad ( 17 )$$

The controller 15 subsequently carries out an output fixing process for the first light source 11B (step S7). Specifically, the controller 15 reads the output fixing coefficients k_{B00} to k_{Bij} out of the control parameters relating to the first light source 11B from the memory. The controller 15 then calculates a first drive current setting value If_{B} based on the output fixing coefficients k_{B00} to k_{Bij}, the first measured value Tm_{B}, and the first power setting value Po_{B}. Specifically, the controller 15 calculates the first drive current setting value If_{B} by substituting the output fixing coefficients k_{B00} to k_{Bij}, the first measured value Tm_{B}, and the first power setting value Po_{B} into Expression (18) below.

$${If}_{B} = {k}_{{B}_{00}} \cdot {Tm}_{B}^{0} \cdot {Po}_{B}^{0} + … + {k}_{{B}_{ij}} \cdot {Tm}_{B}^{i} \cdot {Po}_{B}^{j} \qquad ( 18 )$$

The controller 15 subsequently carries out the output fixing process for the second light source 11G (step S8). Specifically, the controller 15 reads the output fixing coefficients k_{G00} to k_{Gij} out of the control parameters relating to the second light source 11G from the memory. The controller 15 then calculates a second drive current setting value If_{G} based on the output fixing coefficients k_{G00} to K_{Gij}, the second measured value Tm_{G}, and the second power setting value Po_{G}. Specifically, the controller 15 calculates the second drive current setting value If_{G} by substituting the output fixing coefficients k_{G00} to k_{Gij}, the second measured value Tm_{G}, and the second power setting value Po_{G} into Expression (19) below.

$${If}_{G} = {k}_{{G}_{00}} \cdot {Tm}_{G}^{0} \cdot {Po}_{G}^{0} + … + {k}_{{G}_{ij}} \cdot {Tm}_{G}^{i} \cdot {Po}_{G}^{j} \qquad ( 19 )$$

The controller 15 subsequently carries out the output fixing process for the third light source 11R (step S9). Specifically, the controller 15 reads the output fixing coefficients k_{R00} to k_{Rij} out of the control parameters relating to the third light source 11R from the memory. The controller 15 then calculates a third drive current setting value If_{R} based on the output fixing coefficients k_{R00} to k_{Rij}, the third measured value Tm_{R}, and the third power setting value Po_{R}. Specifically, the controller 15 calculates the third drive current setting value If_{R} by substituting the output fixing coefficients k_{R00} to k_{Rij}, the third measured value Tm_{R}, and the third power setting value Po_{R} into Expression (20) below.

$${If}_{R} = {k}_{{R}_{00}} \cdot {Tm}_{R}^{0} \cdot {Po}_{R}^{0} + … + {k}_{{R}_{ij}} \cdot {Tm}_{R}^{i} \cdot {Po}_{R}^{j} \qquad ( 20 )$$

The controller 15 subsequently controls the drive current supplied to each of the light sources (step S10). Specifically, the controller 15 controls the first light source driver 13B in such a way that the value of the first drive current supplied from the first light source driver 13B to the first light source 11B becomes the first drive current setting value If_{B}. The controller 15 further controls the second light source driver 13G in such a way that the value of the second drive current supplied from the second light source driver 13G to the second light source 11G becomes the second drive current setting value If_{G}. The controller 15 still further controls the third light source driver 13R in such a way that the value of the third drive current supplied from the third light source driver 13R to the third light source 11R becomes the third drive current setting value If_{R}.

After the process in step S10 ends, the controller 15 returns to step S2 and repeatedly carries out the processes from steps S2 to S10 in a predetermined cycle.

### Advantages of first embodiment

As described above, the light source apparatus 10 according to the first embodiment includes the first light source 11B, which outputs the first light BL, the second light source 11G, which outputs the second light GL, the third light source 11R, which outputs the third light RL, the first sensor 14B, which detects the first measured value corresponding to the temperature of the first light source 11B, the second sensor 14G, which detects the second measured value corresponding to the temperature of the second light source 11G, the third sensor 14R, which detects the third measured value corresponding to the temperature of the third light source 11R, and the controller 15. The controller 15 controls the output from the first light source 11B based on the first measured value, controls the output from the second light source 11G based on the second measured value, and controls the output from the third light source 11R based on the third measured value.

According to the light source apparatus 10 described above, since the outputs from the first light source 11B, the second light source 11G, and the third light source 11R are controlled by using three sensors less expensive than the light quantity sensors used in the related art, the cost of the parts of the light source apparatus 10 can be reduced. Since the outputs from the first light source 11B, the second light source 11G, and the third light source 11R are separately controlled based on the temperatures of the first light source 11B, the second light source 11G, and the third light source 11R, respectively, the white light WL output from the light source apparatus 10 can be accurately controlled.

In the light source apparatus 10 according to the first embodiment, the controller 15 controls the output from the first light source 11B by controlling the first drive current, which is supplied to the first light source 11B, based on the first measured value. The controller 15 further controls the output from the second light source 11G by controlling the second drive current, which is supplied to the second light source 11G, based on the second measured value. The controller 15 still further controls the output from the third light source 11R by controlling the third drive current, which is supplied to the third light source 11R, based on the third measured value.

According to the light source apparatus 10 described above, the output from the first light source 11B can be readily controlled by controlling the first drive current based on the first measured value. The output from the second light source 11G can also be readily controlled by controlling the second drive current based on the second measured value. Furthermore, the output from the third light source 11R can be readily controlled by controlling the third drive current based on the third measured value.

In the light source apparatus 10 according to the first embodiment, the controller 15 calculates the first power setting value Po_{B} for the first light source 11B, the second power setting value Po_{G} for the second light source 11G, and the third power setting value Po_{R} for the third light source 11R based on the target values (Yxy) expressed in the XYZ color system, the first standard value (X_{B0}, Y_{B0}, Z_{B0}) expressed in the XYZ color system and set in advance in correspondence with the first light source 11B, the second standard value (X_{G0}, Y_{G0}, Z_{G0}) expressed in the XYZ color system and set in advance in correspondence with the second light source 11G, and the third standard value (X_{R0}, Y_{R0}, Z_{R0}) expressed in the XYZ color system and set in advance in correspondence with the third light source 11R. The controller 15 calculates the first drive current setting value If_{B} based on the first measured value, the first coefficient (k_{B00} to k_{Bij}) set in advance in correspondence with the first light source 11B, and the first power setting value Po_{B}. The controller 15 calculates the second drive current setting value If_{G} based on the second measured value, the second coefficient (k_{G00} to k_{Gij}) set in advance in correspondence with the second light source 11G, and the second power setting value Po_{G}. The controller 15 calculates the third drive current setting value If_{R} based on the third measured value, the third coefficient (k_{R00} to k_{Rij}) set in advance in correspondence with the third light source 11R, and the third power setting value Po_{R}.

According to the light source apparatus 10 described above, drive current setting values that can achieve the target values can be accurately calculated in accordance with changes in the temperatures of the light sources.

In the light source apparatus 10 according to the first embodiment, before calculating the first power setting value Po_{B}, the second power setting value Po_{G}, and the third power setting value Po_{R}, the controller 15 corrects the first standard value based on the first measured value and the first correction coefficient set in advance in correspondence with the first light source 11B, corrects the second standard value based on the second measured value and the second correction coefficient set in advance in correspondence with the second light source 11G, and corrects the third standard value based on the third measured value and the third correction coefficient set in advance in correspondence with the third light source 11R.

According to the light source apparatus 10 described above, even when wavelength shifts occur due to changes in the temperatures of the light sources, the first, second, and third standard values are corrected in terms of temperature, so that the drive current setting values can be accurately calculated in accordance with the changes in the temperatures of the light sources.

### Second Embodiment of Light Source Apparatus

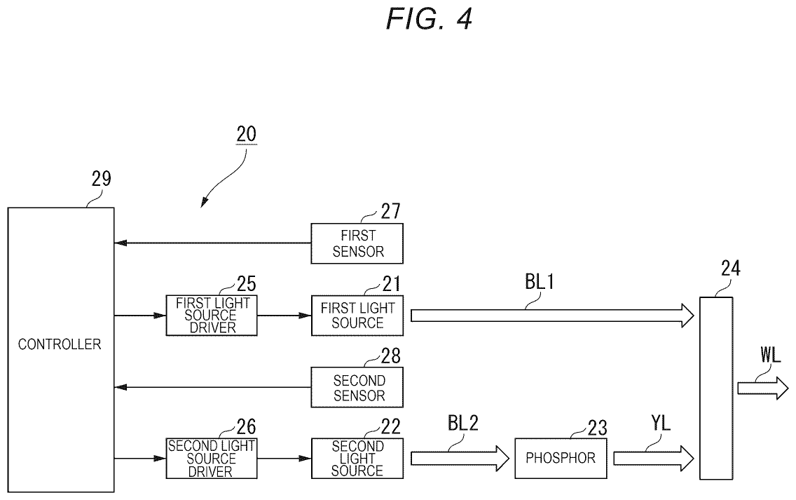

FIG. 4 is a block diagram diagrammatically showing the configuration of a light source apparatus 20 according to a second embodiment. The light source apparatus 20 includes a first light source 21, a second light source 22, a phosphor 23, a light combiner 24, a first light source driver 25, a second light source driver 26, a first sensor 27, a second sensor 28, and a controller 29, as shown in FIG. 4.

The first light source 21 outputs first light BL1. The first light source 21 outputs blue light as the first light BL1 by way of example. For example, the first light source 21 may include one or more blue laser diodes to output blue light as the first light BL1. The first light source driver 25 supplies the first light source 21 with the first drive current. The output from the first light source 21 is controlled by the first drive current.

The second light source 22 outputs second light BL2. The second light source 22 outputs blue light as the second light BL2 by way of example. For example, the second light source 22 may include one or more blue laser diodes to output blue light as the second light BL2. The second light source driver 26 supplies the second light source 22 with the second drive current. The output from the second light source 22 is controlled by the second drive current.

The phosphor 23 converts the second light BL2 output from the second light source 22 into fourth light YL, which is yellow light. The light combiner 24 combines the first light BL1, which is blue light, and the fourth light YL, which is yellow light. The light combiner 12 outputs white light WL as a result of the combination of the first light BL1 and the fourth light YL. That is, the light source apparatus 20 outputs the white light WL.

The first light source driver 25 supplies the first light source 21 with the first drive current based on a first control signal output from the controller 29. The value of the first drive current supplied from the first light source driver 25 to the first light source 21 is controlled by the controller 29.

The second light source driver 26 supplies the second light source 22 with the second drive current based on a second control signal output from the controller 29. The value of the second drive current supplied from the second light source driver 26 to the second light source 22 is controlled by the controller 29.

The first sensor 27 detects a first measured value corresponding to the temperature of the first light source 21. The first sensor 27 outputs an electric signal indicating the first measured value to the controller 29. The second sensor 28 detects a second measured value corresponding to the temperature of the second light source 22. The second sensor 28 outputs an electric signal indicating the second measured value to the controller 29. For example, the first sensor 27 and the second sensor 28 are each a thermistor.

The controller 29 separately controls the output from the first light source 21 and the output from the second light source 22. As will be described later in detail, the controller 29 controls the output from the first light source 21 based on the first measured value detected by the first sensor 27. The controller 29 controls the output from the second light source 22 based on the second measured value detected by the second sensor 28.

More specifically, the controller 29 controls the output from the first light source 21 by controlling the first drive current, which is supplied to the first light source 21, based on the first measured value. The controller 29 further controls the output from the second light source 22 by controlling the second drive current, which is supplied to the second light source 22, based on the second measured value.

For example, the controller 29 includes one or more processors and one or more memories, and control parameters necessary for controlling the first light source 21 and the second light source 22 are stored in advance in a nonvolatile memory of the controller 29, as in the controller 15 in the first embodiment. The method for acquiring the control parameters is the same as that in the first embodiment, and is therefore not repeatedly described in the second embodiment.

As the control parameters necessary for controlling the first light source 21, output fixing coefficients k_{B00} to k_{Bij}, a standard value X_{B0} of the X component, a standard value Y_{B0} of the Y component, a standard value Z_{B0} of the Z component, a wavelength shift correction coefficient K_{BX} of the X component, a wavelength shift correction coefficient K_{BY} of the Y component, and a wavelength shift correction coefficient K_{BZ} of the Z component are stored in the memory.

As the control parameters necessary for controlling the second light source 22, output fixing coefficients k_{Y00} to k_{Yij}, a standard value X_{Y0} of the X component, a standard value Y_{Y0} of the Y component, a standard value Z_{Y0} of the Z component, a wavelength shift correction coefficient K_{YX} of the X component, a wavelength shift correction coefficient K_{YY} of the Y component, and a wavelength shift correction coefficient K_{YZ} of the Z component are stored in the memory.

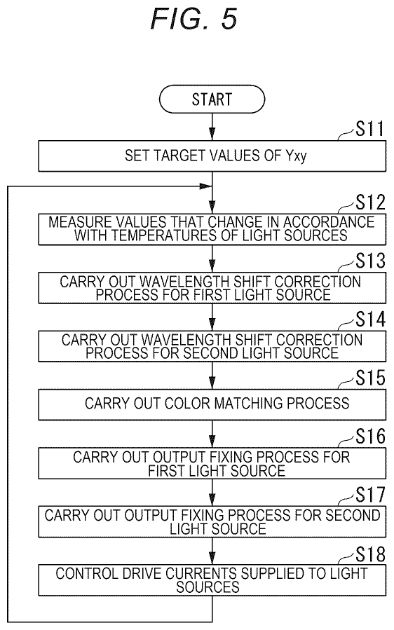

A light source control process carried out by the controller 29 will be described below with reference to FIG. 5. FIG. 5 is a flowchart showing the light source control process carried out by the controller 29.

The controller 29 first sets a target value of the Y component and target values of the color coordinate xy (step S11), as shown in FIG. 5. The target value of the Y component and the target values of the color coordinate xy are examples of a target value expressed in the first color system.

The controller 29 subsequently measures values that change in accordance with the temperatures of the first light source 21 and the second light source 22 (step S12). Specifically, the controller 29 acquires a first measured value Tm_{B} corresponding to the temperature of the first light source 21 based on the output signal from the first sensor 27. The controller 29 further acquires a second measured value Tm_{Y} corresponding to the temperature of the second light source 22 based on the output signal from the second sensor 28.

The controller 29 subsequently carries out a wavelength shift correction process for the first light source 21 (step S13). Specifically, the controller 29 reads the standard value X_{B0} of the X component and the wavelength shift correction coefficient K_{BX} of the X component out of the control parameters relating to the first light source 21 from the memory. The controller 29 then corrects the standard value X_{B0} of the X component based on the first measured value Tm_{B} and the wavelength shift correction coefficient K_{BX} of the X component. Specifically, the controller 29 calculates a reference value X_{B1} of the X component relating to the first light source 21 by substituting the standard value X_{B0} of the X component, the wavelength shift correction coefficient K_{BX} of the X component, and the first measured value Tm_{B} into Expression (5) shown above.

The controller 29 reads the standard value Y_{B0} of the Y component and the wavelength shift correction coefficient K_{BY} of the Y component out of the t control parameters relating to the first light source 21 from the memory. The controller 29 then corrects the standard value Y_{B0} of the Y component based on the first measured value Tm_{B} and the wavelength shift correction coefficient K_{BY} of the Y component. Specifically, the controller 29 calculates a reference value Y_{B1} of the Y component relating to the first light source 21 by substituting the standard value Y_{B0} of the Y component, the wavelength shift correction coefficient K_{BY} of the Y component, and the first measured value Tm_{B} into Expression (6) shown above.

The controller 29 further reads the standard value Z_{B0} of the Z component and the wavelength shift correction coefficient K_{BZ} of the Z component out of the control parameters relating to the first light source 21 from the memory. The controller 29 then corrects the standard value Z_{B0} of the Z component based on the first measured value Tm_{B} and the wavelength shift correction coefficient K_{BZ} of the Z component. Specifically, the controller 29 calculates a reference value Z_{B1} of the Z component relating to the first light source 21 by substituting the standard value Z_{B0} of the Z component, the wavelength shift correction coefficient K_{BZ} of the Z component, and the first measured value Tm_{B} into Expression (7) shown above.

The controller 29 subsequently carries out the wavelength shift correction process for the second light source 22 (step S14). Specifically, the controller 29 reads the standard value X_{Y0} of the X component and the wavelength shift correction coefficient K_{YX} of the X component out of the control parameters relating to the second light source 22 from the memory. The controller 29 then corrects the standard value X_{Y0} of the X component based on the second measured value Tm_{Y} and the wavelength shift correction coefficient K_{YX} of the X component. Specifically, the controller 29 calculates a reference value X_{Y1} of the X component relating to the second light source 22 by substituting the standard value X_{Y0} of the X component, the wavelength shift correction coefficient K_{YX} of the X component, and the second measured value Tm_{Y} into Expression (21) below.

The controller 29 further reads the standard value Y_{Y0} of the Y component and the wavelength shift correction coefficient K_{YY} of the Y component out of the control parameters relating to the second light source 22 from the memory. The controller 29 then corrects the standard value Y_{Y0} of the Y component based on the second measured value Tm_{Y} and the wavelength shift correction coefficient K_{YY} of the Y component. Specifically, the controller 29 calculates a reference value Y_{Y1} of the Y component relating to the second light source 22 by substituting the standard value Y_{Y0} of the Y component, the wavelength shift correction coefficient K_{YY} of the y component, and the second measured value Tm_{Y} into Expression (22) below.

The controller 29 still further reads the standard value Z_{Y0} of the Z component and the wavelength shift correction coefficient K_{YZ} of the Z component out of the control parameters relating to the second light source 22 from the memory. The controller 29 then corrects the standard value Z_{Y0} of the Z component based on the second measured value Tm_{Y} and the wavelength shift correction coefficient K_{YZ} of the Z component. Specifically, the controller 29 calculates a reference value Z_{Y1} of the Z component relating to the second light source 22 by substituting the standard value Z_{Y0} of the Z component, the wavelength shift correction coefficient K_{YZ} of the Z component, and the second measured value Tm_{Y} into Expression (23) below.

$$\{ \begin{matrix}{X}_{Y 1} = {X}_{Y 0} \cdot {K}_{YX} \cdot {Tm}_{Y} & ( 21 ) \\ {Y}_{Y 1} = {Y}_{Y 0} \cdot {K}_{Y Y} \cdot {Tm}_{Y} & ( 22 ) \\ {Z}_{Y 1} = {Z}_{Y 0} \cdot {K}_{Y Z} \cdot {Tm}_{Y} & ( 23 )\end{matrix}$$

The controller 29 subsequently carries out a color matching process (step S15). Specifically, the controller 29 calculates a first power setting value Po_{B} for the first light source 21 and a second power setting value Po_{Y} for the second light source 22. A target value of the X component is expressed by Expression (24) below. A target value of the Y component is expressed by Expression (25) below. A target value of the Z component is expressed by Expression (26) below.

$$\{ \begin{matrix}X = \frac{Y}{y} x = {Po}_{Y} \cdot {X}_{Y 1} + {Po}_{B} \cdot {X}_{B 1} & ( 24 ) \\ Y = Y = {Po}_{Y} \cdot {Y}_{Y 1} + {Po}_{B} \cdot {Y}_{B 1} & ( 25 ) \\ Z = \frac{Y}{y} ( 1 - x - y ) = {Po}_{Y} \cdot {Z}_{Y 1} + {Po}_{B} \cdot {Z}_{B 1} & ( 26 )\end{matrix}$$

When Expressions (24), (25), and (26) described above are transformed into a determinant, Expression (27) below is obtained. The controller 29 solves simultaneous equations based on Expression (27) below to calculate the first power setting value Po_{B} for the first light source 21 and the second power setting value Po_{Y} for the second light source 22.

$$( \begin{matrix}X \\ Y \\ Z\end{matrix} ) = ( \begin{matrix}\frac{Y}{y} x \\ Y \\ \frac{Y}{y} ( 1 - x - y )\end{matrix} ) = ( \begin{matrix}0 & {X}_{Y 1} & {X}_{B 1} \\ 0 & {Y}_{Y 1} & {Y}_{B 1} \\ 0 & {Z}_{Y 1} & {Z}_{B 1}\end{matrix} ) ( \begin{matrix}0 \\ {Po}_{Y} \\ {Po}_{B}\end{matrix} ) \qquad ( 27 )$$

The controller 29 subsequently carries out an output fixing process for the first light source 21 (step S16). Specifically, the controller 29 reads the output fixing coefficients k_{B00} to k_{Bij} out of the control parameters relating to the first light source 21 from the memory. The controller 29 then calculates a first drive current setting value If_{B} based on the output fixing coefficients k_{B00} to k_{Bij}, the first measured value Tm_{B}, and the first power setting value Po_{B}. Specifically, the controller 29 calculates the first drive current setting value If_{B} by substituting the output fixing coefficients k_{B00} to k_{Bij}, the first measured value Tm_{B}, and the first power setting value Po_{B} into Expression (18) shown above.

The controller 29 subsequently carries out the output fixing process for the second light source 22 (step S17). Specifically, the controller 29 reads the output fixing coefficients k_{Y00} to k_{Yij} out of the control parameters relating to the second light source 22 from the memory. The controller 29 then calculates a second drive current setting value If_{Y} based on the output fixing coefficients k_{Y00} to k_{Yij}, the second measured value Tm_{Y}, and the second power setting value Po_{Y}. Specifically, the controller 29 calculates the second drive current setting value If_{Y} by substituting the output fixing coefficients k_{Y00} to k_{Yij}, the second measured value Tm_{Y}, and the second power setting value Po_{Y} into Expression (28) below.

$${If}_{Y} = {k}_{{Y}_{00}} \cdot {Tm}_{Y}^{0} \cdot {Po}_{Y}^{0} + … + {k}_{{Y}_{ij}} \cdot {Tm}_{Y}^{i} \cdot {Po}_{Y}^{j} \qquad ( 28 )$$

The controller 29 subsequently controls the drive current supplied to each of the light sources (step S18). Specifically, the controller 29 controls the first light source driver 25 in such a way that the value of the first drive current supplied from the first light source driver 25 to the first light source 21 becomes the first drive current setting value If_{B}. The controller 29 further controls the second light source driver 26 in such a way that the value of the second drive current supplied from the second light source driver 26 to the second light source 22 becomes the second drive current setting value If_{Y}.

After the process in step S18 ends, the controller 29 returns to step S12 and repeatedly carries out the processes from steps S12 to S18 in a predetermined cycle.

### Advantages of Second Embodiment

As described above, the light source apparatus 20 according to the second embodiment includes the first light source 21, which outputs the first light BL1, the second light source 22, which outputs the second light BL2, the first sensor 27, which detects the first measured value corresponding to the temperature of the first light source 21, the second sensor 28, which detects the second measured value corresponding to the temperature of the second light source 22, and the controller 29. The controller 29 controls the output from the first light source 21 based on the first measured value, and controls the output from the second light source 22 based on the second measured value.

According to the light source apparatus 20 described above, since the outputs from the first light source 21 and the second light source 22 are controlled by using two sensors less expensive than the light quantity sensors used in the related art, the cost of the parts of the light source apparatus 20 can be reduced. Since the outputs from the first light source 21 and the second light source 22 are separately controlled based on the temperatures of the first light source 21 and the second light source 22, respectively, the white light WL output from the light source apparatus 20 can be accurately controlled.

In the light source apparatus 20 according to the second embodiment, the controller 29 controls the output from the first light source 21 by controlling the first drive current, which is supplied to the first light source 21, based on the first measured value. The controller 29 further controls the output from the second light source 22 by controlling the second drive current, which is supplied to the second light source 22, based on the second measured value.

According to the light source apparatus 20 described above, the output from the first light source 21 can be readily controlled by controlling the first drive current based on the first measured value. The output from the second light source 22 can also be readily controlled by controlling the second drive current based on the second measured value.

In the light source apparatus 20 according to the second embodiment, the controller 29 calculates the first power setting value Po_{B} for the first light source 21 and the second power setting value Po_{Y} Y for the second light source 22 based on the target values (Yxy) expressed in the XYZ color system, the first standard value (X_{B0}, Y_{B0}, Z_{B0}) expressed in the XYZ color system and set in advance in correspondence with the first light source 21, and the second standard value (X_{Y0}, Y_{Y0}, Z_{Y0}) expressed in the XYZ color system and set in advance in correspondence with the second light source 22. The controller 29 calculates the first drive current setting value If_{B} based on the first measured value, the first coefficient (k_{B00} to k_{Bij}) set in advance in correspondence with the first light source 21, and the first power setting value Po_{B}. The controller 29 calculates the second drive current setting value If_{Y} based on the second measured value, the second coefficient (k_{Y00} to k_{Yij}) set in advance in correspondence with the second light source 22, and the second power setting value Po_{Y}.

According to the light source apparatus 20 described above, drive current setting values that can achieve the target values can be accurately calculated in accordance with changes in the temperatures of the light sources.

In the light source apparatus 20 according to the second embodiment, before calculating the first power setting value Po_{B} and the second power setting value Po_{Y}, the controller 29 corrects the first standard value based on the first measured value and the first correction coefficient set in advance in correspondence with the first light source 21, and corrects the second standard value based on the second measured value and the second correction coefficient set in advance in correspondence with the second light source 22.

According to the light source apparatus 20 described above, even when wavelength shifts occur due to changes in the temperatures of the light sources, the first and second standard values are corrected in terms of temperature, so that the drive current setting values can be accurately calculated in accordance with the changes in the temperatures of the light sources.

### Third Embodiment of Light Source Apparatus

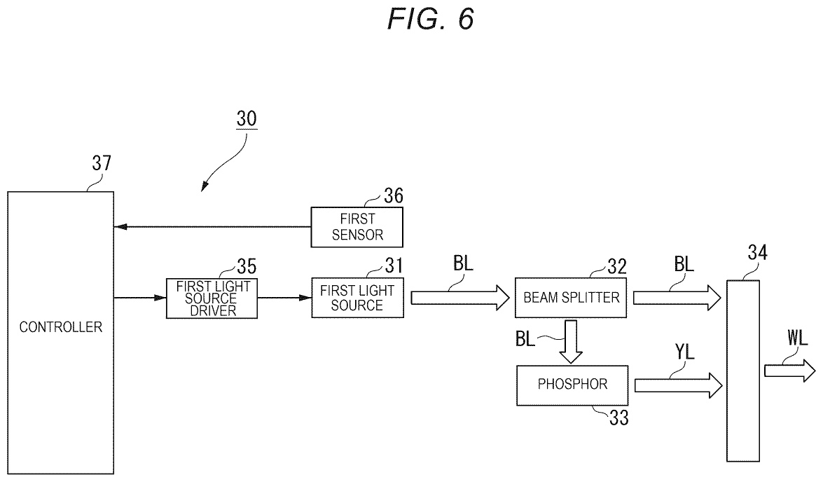

FIG. 6 is a block diagram diagrammatically showing the configuration of a light source apparatus 30 according to a third embodiment. The light source apparatus 30 includes a first light source 31, a beam splitter 32, a phosphor 33, a light combiner 34, a first light source driver 35, a first sensor 36, and a controller 37, as shown in FIG. 6.

The first light source 31 outputs first light BL. The first light source 31 outputs blue light as the first light BL by way of example. For example, the first light source 31 may include one or more blue laser diodes to output blue light as the first light BL. The first light source driver 35 supplies the first light source 31 with the first drive current. The output of the first light source 31 is controlled by the first drive current.

The beam splitter 32 outputs the first light BL to the phosphor 33 and the light combiner 34. The phosphor 33 converts the first light BL incident from the beam splitter 32 into fourth light YL, which is yellow light. The light combiner 34 combines the blue first light BL incident from the beam splitter 32 and the yellow fourth light YL incident from the phosphor 33 with each other. The light combiner 34 outputs white light WL as a result of the combination of the first light BL and the fourth light YL. That is, the light source apparatus 30 outputs the white light WL.

The first light source driver 35 supplies the first light source 31 with the first drive current based on a first control signal output from the controller 37. The value of the first drive current supplied from the first light source driver 35 to the first light source 31 is controlled by the controller 37.

The first sensor 36 detects a first measured value corresponding to the temperature of the first light source 31. The first sensor 36 outputs an electric signal indicating the first measured value to the controller 37. For example, the first sensor 36 is a thermistor.

The controller 37 controls the output from the first light source 31. As will be described later in detail, the controller 37 controls the output from the first light source 31 based on the first measured value detected by the first sensor 36. More specifically, the controller 37 controls the output from the first light source 31 by controlling the first drive current, which is supplied to the first light source 31, based on the first measured value.

For example, the controller 37 includes one or more processors and one or more memories, and control parameters necessary for controlling the first light source 31 are stored in advance in a nonvolatile memory of the controller 37, as in the controller 15 in the first embodiment. The method for acquiring the control parameters is the same as that in the first embodiment, and is therefore not repeatedly described in the third embodiment.

As the control parameters necessary for controlling the first light source 31, output fixing coefficients k_{B00} to k_{Bij}, a standard value X_{B0} of the X component, a standard value Y_{B0} of the Y component, a standard value Z_{B0} of the Z component, a wavelength shift correction coefficient K_{BX} of the X component, a wavelength shift correction coefficient K_{BY} of the Y component, and a wavelength shift correction coefficient K_{BZ} of the Z component are stored in the memory.

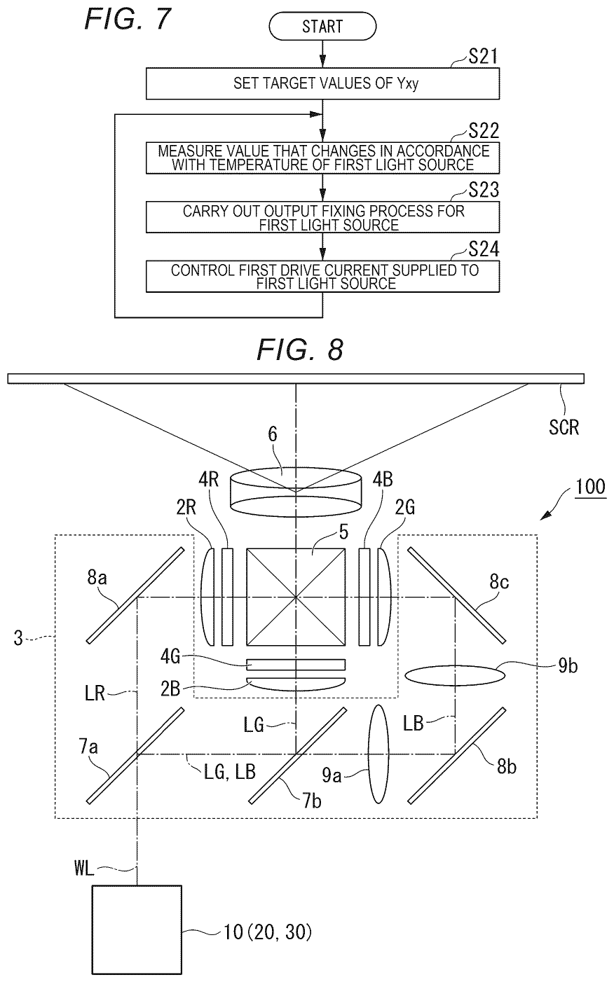

A light source control process carried out by the controller 37 will be described below with reference to FIG. 7. FIG. 7 is a flowchart showing the light source control process carried out by the controller 37.

The controller 37 first sets a target value of the Y component and target values of the color coordinate xy (step S21), as shown in FIG. 7. The target value of the Y component and the target values of the color coordinate xy are examples of a target value expressed in the first color system.

The controller 37 subsequently measures a value that changes in accordance with the temperature of the first light source 31 (step S22). Specifically, the controller 37 acquires a first measured value Tm_{B} corresponding to the temperature of the first light source 31 based on the output signal from the first sensor 36.

The controller 37 subsequently carries out an output fixing process for the first light source 31 (step S23). Specifically, the controller 37 reads output fixing coefficients k_{B00} to k_{Bij} out of the control parameters relating to the first light source 31 from the memory. The controller 37 then calculates a first drive current setting value If_{B} based on the output fixing coefficients k_{B00} to k_{Bij}, the first measured value Tm_{B}, and the first power setting value Po_{B}. Specifically, the controller 37 calculates the first drive current setting value If_{B} by substituting the output fixing coefficients k_{B00} to k_{Bij}, the first measured value Tm_{B}, and the first power setting value Po_{B} into Expression (18) shown above. Note that when the number of light sources is one as in the third embodiment, the first power setting value Po_{B} is a fixed value.

The controller 37 subsequently controls the first drive current supplied to the first light source 31 (step S24). Specifically, the controller 37 controls the first light source driver 35 in such a way that the value of the first drive current supplied from the first light source driver 35 to the first light source 31 becomes the first drive current setting value If_{B}.

After the process in step S24 ends, the controller 37 returns to step S22 and repeatedly carries out the processes from steps S22 to S24 in a predetermined cycle.

### Advantages of Third Embodiment

As described above, the light source apparatus 30 according to the third embodiment includes the first light source 31, which outputs the first light BL, the first sensor 36, which detects the first measured value corresponding to the temperature of the first light source 31, and the controller 37, which controls the output from the first light source 31 based on the first measured value.

According to the light source apparatus 30 described above, since the output from the first light source 31 is controlled by using one sensor less expensive than the two light quantity sensors used in the related art, the number and the cost of the parts of the light source apparatus 30 can be reduced. Since the output from the first light source 21 is controlled based on the temperature of the first light source 21, the white light WL output from the light source apparatus 30 can be accurately controlled.

In the light source apparatus 30 according to the third embodiment, the controller 37 controls the output from the first light source 31 by controlling the first drive current, which is supplied to the first light source 31, based on the first measured value.

According to the light source apparatus 30 described above, the output from the first light source 31 can be readily controlled by controlling the first drive current based on the first measured value.

In the light source apparatus 30 according to the third embodiment, the controller 37 calculates the first drive current setting value If_{B} based on the first measured value, the first coefficient (k_{B00} to k_{Bij}) set in advance in correspondence with the first light source 31, and the first power setting value Po_{B}.

According to the light source apparatus 30 described above, the first drive current setting value If_{B} that can achieve the target values can be accurately calculated in accordance with a change in the temperature of the first light source 31. Furthermore, according to the light source apparatus 30 described above, since the wavelength shift correction process and the color matching process described in the first and second embodiments can be omitted, the calculation load on the controller 37 can be reduced.

### Projector

FIG. 8 diagrammatically shows the configuration of a projector 100 according to the present embodiment.

The projector 100 is a projection-type image display apparatus that displays video images on a screen SCR, as shown in FIG. 8. The projector 100 includes the light source apparatus 10 according to the first embodiment, a color separation system 3, light modulators 4R, 4G, and 4B, a light combining system 5, and a projection system 6. Note that the projector 100 may include the light source apparatus 20 according to the second embodiment or the light source apparatus 30 according to the third embodiment in place of the light source apparatus 10 according to the first embodiment.

The light source apparatus 10 outputs the white light WL toward the color separation system 3. The color separation system 3 separates the white light WL output from the light source apparatus 10 into red light LR, green light LG, and blue light LB. The color separation system 3 includes a first dichroic mirror 7a, a second dichroic mirror 7b, a first total reflection mirror 8a, a second total reflection mirror 8b, a third total reflection mirror 8c, a first relay lens 9a, and a second relay lens 9b.

The first dichroic mirror 7a separates the white light WL from the light source apparatus 10 into the red light LR and light containing the green light LG and the blue light LB. The first dichroic mirror 7a transmits the red light LR and reflects the light containing the green light LG and the blue light LB. The second dichroic mirror 7b reflects the green light LG and transmits the blue light LB. The second dichroic mirror 7b thus separates the light incident from the first dichroic mirror 7a into the green light LG and the blue light LB.

The first total reflection mirror 8a is disposed in the optical path of the red light LR, and reflects the red light LR having passed through the first dichroic mirror 7a toward the light modulator 4R. The second total reflection mirror 8b and the third total reflection mirror 8c are disposed in the optical path of the blue light LB, and guide the blue light LB having passed through the second dichroic mirror 7b to the light modulator 4B. The green light LG is reflected off the second dichroic mirror 7b toward the light modulator 4G.

The first relay lens 9a and the second relay lens 9b are disposed in the optical path of the blue light LB on the light exiting side of the second total reflection mirror 8b. The first relay lens 9a and the second relay lens 9b compensate for optical loss of the blue light LB resulting from the fact that the optical path length of the blue light LB is longer than the optical path lengths of the red light LR and the green light LG.

The light modulator 4R modulates the red light LR in accordance with image information to form image light corresponding to the red light LR. The light modulator 4G modulates the green light LG in accordance with image information to form image light corresponding to the green light LG. The light modulator 4B modulates the blue light LB in accordance with image information to form image light corresponding to the blue light LB.

The light modulators 4R, 4G, and 4B are each, for example, a transmissive liquid crystal panel. Polarizers that are not shown are disposed at the light incident and exiting sides of each of the liquid crystal panels.

A field lens 2R is disposed on the light incident side of the light modulator 4R. The field lens 2R parallelizes the red light LR to be incident on the light modulator 4R. A field lens 2G is disposed on the light incident side of the light modulator 4G. The field lens 2G parallelizes the green light LG to be incident on the light modulator 4G. A field lens 2B is disposed on the light incident side of the light modulator 4B. The field lens 2B parallelizes the blue light LB to be incident on the light modulator 4B.

The image light output from the light modulator 4R, the image light output from the light modulator 4G, and the image light output from the light modulator 4B enter the light combining system 5. The light combining system 5 combines the image light corresponding to the red light LR, the image light corresponding to the green light LG, and the image light corresponding to the blue light LB with one another and outputs the combined image light toward the projection system 6. The light combining system 5 is, for example, a cross dichroic prism.

The projection system 6 includes multiple projection lenses. The projection system 6 enlarges the combined image light from the light combining system 5 and projects the enlarged image light toward the screen SCR. Enlarged video images are thus displayed on the screen SCR.

Note that the technical scope of the present disclosure is not limited to the embodiments described above, and various changes can be made thereto without departing from the intent of the present disclosure.

For example, the projector 100 including the light source apparatus 10 is presented by way of example in the embodiments described above, and the light source apparatus according to the present disclosure can be widely used as a light source apparatus of an electronic instrument other than the projector 100.

### SUMMARY OF PRESENT DISCLOSURE

The present disclosure will be summarized below as additional remarks.

(Additional Remark 1) A light source apparatus including: a first light source configured to output first light; a first sensor configured to detect a first measured value corresponding to a temperature of the first light source; and a controller configured to control an output from the first light source based on the first measured value.

The light source apparatus according to Additional Remark 1, in which the output from the first light source is controlled by using one sensor less expensive than the two light quantity sensors used in the related art, allows reduction in the number and the cost of the parts of the light source apparatus. Since the output from the first light source is controlled based on the temperature of the first light source, the light output from the light source apparatus can be accurately controlled.

(Additional Remark 2) The light source apparatus according to Additional Remark 1, wherein the controller is configured to control the output from the first light source by controlling a first drive current, which is supplied to the first light source, based on the first measured value.

The light source apparatus according to Additional Remark 2 can readily control the output from the first light source by controlling the first drive current based on the first measured value.

(Additional Remark 3) The light source apparatus according to Additional Remark 2, wherein the controller is configured to calculate a value that sets the first drive current based on the first measured value, a first coefficient set in advance in correspondence with the first light source, and a first power setting value for the first light source.

In the light source apparatus according to Additional Remark 3, the value that sets a first drive current that can achieve a target value can be accurately calculated in accordance with a change in the temperature of the first light source.

(Additional Remark 4) The light source apparatus according to Additional Remark 1 further including: a second light source configured to output second light; and a second sensor configured to detect a second measured value corresponding to a temperature of the second light source, wherein the controller is configured to control an output from the second light source based on the second measured value.

The light source apparatus according to Additional Remark 4, in which the outputs from the first and second light sources are controlled by using two sensors less expensive than the light quantity sensors used in the related art, allows reduction in the cost of the parts of the light source apparatus. Since the outputs from the first and second light sources are separately controlled based on the temperatures of the first and second light sources, respectively, the light output from the light source apparatus can be accurately controlled.

(Additional Remark 5) The light source apparatus according to Additional Remark 4, wherein the controller is configured to control the output from the first light source by controlling a first drive current, which is supplied to the first light source, based on the first measured value, and control the output from the second light source by controlling a second drive current, which is supplied to the second light source, based on the second measured value.

The light source apparatus according to Additional Remark 5 can readily control the output from the first light source by controlling the first drive current based on the first measured value. The output from the second light source can also be readily controlled by controlling the second drive current based on the second measured value.

(Additional Remark 6) The light source apparatus according to Additional Remark 5, wherein the controller is configured to calculate a first power setting value for the first light source and a second power setting value for the second light source based on a target value expressed in a first color system, a first standard value expressed in the first color system and set in advance in correspondence with the first light source, and a second standard value expressed in the first color system and set in advance in correspondence with the second light source, calculate a value that sets the first drive current based on the first measured value, a first coefficient set in advance in correspondence with the first light source, and the first power setting value, and calculate a value that sets the second drive current based on the second measured value, a second coefficient set in advance in correspondence with the second light source, and the second power setting value.

In the light source apparatus according to Additional Remark 6, the values that set drive currents that can achieve the target value can be accurately calculated in accordance with changes in the temperatures of the light sources.

(Additional Remark 7) The light source apparatus according to Additional Remark 6, wherein before calculating the first and second power setting values, the controller is configured to correct the first standard value based on the first measured value and a first correction coefficient set in advance in correspondence with the first light source, and correct the second standard value based on the second measured value and a second correction coefficient set in advance in correspondence with the second light source.

In the light source apparatus according to Additional Remark 7, even when wavelength shifts occur due to changes in the temperatures of the light sources, the first and second standard values are corrected in terms of temperature, so that the values that set the drive currents can be accurately calculated in accordance with the changes in the temperatures of the light sources.

(Additional Remark 8) The light source apparatus according to Additional Remark 4 further including: a third light source configured to output third light; and a third sensor configured to detect a third measured value corresponding to a temperature of the third light source, wherein the controller is configured to control an output from the third light source based on the third measured value.

The light source apparatus according to Additional Remark 8, in which the outputs from the first, second, and third light sources are controlled by using three sensors less expensive than the light quantity sensors used in the related art, allows reduction in the cost of the parts of the light source apparatus. Since the outputs from the first, second, and third light sources are separately controlled based on the temperatures of the first, second, and third light sources, respectively, the light output from the light source apparatus can be accurately controlled.

(Additional Remark 9) The light source apparatus according to Additional Remark 8, wherein the controller is configured to control the output from the first light source by controlling a first drive current, which is supplied to the first light source, based on the first measured value, control the output from the second light source by controlling a second drive current, which is supplied to the second light source, based on the second measured value, and control the output from the third light source by controlling a third drive current, which is supplied to the third light source, based on the third measured value.

The light source apparatus according to Additional Remark 9 can readily control the output from the first light source by controlling the first drive current based on the first measured value. The output from the second light source can also be readily controlled by controlling the second drive current based on the second measured value. The output from the third light source can still further be readily controlled by controlling the third drive current based on the third measured value.

(Additional Remark 10) The light source apparatus according to Additional Remark 9, wherein the controller is configured to calculate a first power setting value for the first light source, a second power setting value for the second light source, and a third power setting value for the third light source based on a target value expressed in a first color system, a first standard value expressed in the first color system and set in advance in correspondence with the first light source, a second standard value expressed in the first color system and set in advance in correspondence with the second light source, and a third standard value expressed in the first color system and set in advance in correspondence with the third light source, calculate a value that sets the first drive current based on the first measured value, a first coefficient set in advance in correspondence with the first light source, and the first power setting value, calculate a value that sets the second drive current based on the second measured value, a second coefficient set in advance in correspondence with the second light source, and the second power setting value, and calculate a value that sets the third drive current based on the third measured value, a third coefficient set in advance in correspondence with the third light source, and the third power setting value.

In the light source apparatus according to Additional Remark 10, the values that set drive currents that can achieve the target value can be accurately calculated in accordance with changes in the temperatures of the light sources.

(Additional Remark 11) The light source apparatus according to Additional Remark 10, wherein before calculating the first, second, and third power setting values, the controller is configured to correct the first standard value based on the first measured value and a first correction coefficient set in advance in correspondence with the first light source, correct the second standard value based on the second measured value and a second correction coefficient set in advance in correspondence with the second light source, and correct the third standard value based on the third measured value and a third correction coefficient set in advance in correspondence with the third light source.

In the light source apparatus according to Additional Remark 11, even when wavelength shifts occur due to changes in the temperatures of the light sources, the first, second, and third standard values are corrected in terms of temperature, so that the values that set the drive currents can be accurately calculated in accordance with the changes in the temperatures of the light sources.

(Additional Remark 12) A projector including: the light source apparatus according to any one of Additional Remarks 1 to 11; a light modulator configured to modulate light output from the light source apparatus; and a projection system configured to project the light modulated by the light modulator.

The projector according to Additional Remark 12, which includes the light source apparatus that allows reduction in the number and the cost of the parts of the light source apparatus, allows reduction in the number and the cost of the parts of the projector itself.

What is claimed is:

1. A light source apparatus comprising:
a first light source configured to output first light;
a first sensor configured to detect a first measured value corresponding to a temperature of the first light source; and
a controller configured to control an output from the first light source based on the first measured value.

2. The light source apparatus according to claim 1, wherein
the controller is configured to control the output from the first light source by controlling a first drive current, which is supplied to the first light source, based on the first measured value.

3. The light source apparatus according to claim 2, wherein
the controller is configured to calculate a value that sets the first drive current based on the first measured value, a first coefficient set in advance in correspondence with the first light source, and a first power setting value for the first light source.

4. The light source apparatus according to claim 1 further comprising:
a second light source configured to output second light; and
a second sensor configured to detect a second measured value corresponding to a temperature of the second light source,
wherein the controller is configured to control an output from the second light source based on the second measured value.

5. The light source apparatus according to claim 4, wherein
the controller is configured to
control the output from the first light source by controlling a first drive current, which is supplied to the first light source, based on the first measured value, and
control the output from the second light source by controlling a second drive current, which is supplied to the second light source, based on the second measured value.

6. The light source apparatus according to claim 5, wherein
the controller is configured to
calculate a first power setting value for the first light source and a second power setting value for the second light source based on a target value expressed in a first color system, a first standard value expressed in the first color system and set in advance in correspondence with the first light source, and a second standard value expressed in the first color system and set in advance in correspondence with the second light source,
calculate a value that sets the first drive current based on the first measured value, a first coefficient set in advance in correspondence with the first light source, and the first power setting value, and
calculate a value that sets the second drive current based on the second measured value, a second coefficient set in advance in correspondence with the second light source, and the second power setting value.

7. The light source apparatus according to claim 6, wherein
before calculating the first and second power setting values, the controller is configured to
correct the first standard value based on the first measured value and a first correction coefficient set in advance in correspondence with the first light source, and
correct the second standard value based on the second measured value and a second correction coefficient set in advance in correspondence with the second light source.

8. The light source apparatus according to claim 4 further comprising:
a third light source configured to output third light; and
a third sensor configured to detect a third measured value corresponding to a temperature of the third light source,
wherein the controller is configured to control an output from the third light source based on the third measured value.

9. The light source apparatus according to claim 8, wherein
the controller is configured to
control the output from the first light source by controlling a first drive current, which is supplied to the first light source, based on the first measured value,
control the output from the second light source by controlling a second drive current, which is supplied to the second light source, based on the second measured value, and
control the output from the third light source by controlling a third drive current, which is supplied to the third light source, based on the third measured value.

10. The light source apparatus according to claim 9, wherein
the controller is configured to
calculate a first power setting value for the first light source, a second power setting value for the second light source, and a third power setting value for the third light source based on a target value expressed in a first color system, a first standard value expressed in the first color system and set in advance in correspondence with the first light source, a second standard value expressed in the first color system and set in advance in correspondence with the second light source, and a third standard value expressed in the first color system and set in advance in correspondence with the third light source,
calculate a value that sets the first drive current based on the first measured value, a first coefficient set in advance in correspondence with the first light source, and the first power setting value,
calculate a value that sets the second drive current based on the second measured value, a second coefficient set in advance in correspondence with the second light source, and the second power setting value, and
calculate a value that sets the third drive current based on the third measured value, a third coefficient set in advance in correspondence with the third light source, and the third power setting value.

11. The light source apparatus according to claim 10, wherein
before calculating the first, second, and third power setting values, the controller is configured to
correct the first standard value based on the first measured value and a first correction coefficient set in advance in correspondence with the first light source,
correct the second standard value based on the second measured value and a second correction coefficient set in advance in correspondence with the second light source, and
correct the third standard value based on the third measured value and a third correction coefficient set in advance in correspondence with the third light source.

12. A projector comprising:
the light source apparatus according to claim 1;
a light modulator configured to modulate light output from the light source apparatus; and
a projection system configured to project the light modulated by the light modulator.
